(19) United States
(12) Patent Application Publication
(10) Pub. No.: US 2015/0161642 A1
(43) Pub. Date: Jun. 11, 2015

(54) METHOD AND SYSTEM TO TRACK MERCHANT LOYALTY AND INCENTIVES VIA A CREDIT CARD

(71) Applicant: MasterCard International Incorporated, Purchase, NY (US)

(72) Inventors: Jeremy Pastore, Purchase, NY (US); Michael Thomas McNamara, Purchase, NY (US)

(73) Assignee: MasterCard International Incorporated, Purchase, NY (US)

(21) Appl. No.: 14/099,494

(22) Filed: Dec. 6, 2013

(51) Int. Cl. G06Q 30/02

(52) U.S. Cl. CPC G06Q 30/0224

(57) ABSTRACT

A system and method including receiving, by a computer, an authorization request including a payment account number (PAN) and an identifier of a merchant associated with a transaction, the authorization request being an authorization only type of authorization; determining whether the PAN is associated with a loyalty program of the merchant based on a record of a mapped association between the PAN and a unique account identifier of the merchant's loyalty program; and sending, by the computer, an authorization response in reply to the authorization request, the authorization response including a first indicator indicative of whether the transaction is authorized and a second indicator indicative of whether the PAN included in the authorization request is associated with the loyalty program of the merchant.

### BACKGROUND

Merchant loyalty programs are quite popular for merchants hoping to attract, retain, and increase the revenue generated on a per customer basis. Likewise, merchant loyalty programs are also popular with a sizeable portion of the consuming public as consumers welcome rewards and incentives that offer them savings. Merchant loyalty programs typically assign members enrolled in a loyalty program a unique account identifier for their program so that the purchases and other actions of the loyalty program participants can be tracked and analyzed, in part to increase business. In order to identify loyalty program participants as they interact with the merchant, merchants typically provide the members with a card, key fob, or other indicia that includes their unique account identifier for each merchant's loyalty program so that the members can readily identify themselves as loyalty program member.

In some instances a consumer may have a plurality of loyalty cards, each being associated with a different loyalty program. Some people would rather not carry each and every one of their loyalty cards with them at all times, but they still wish participant in all of the loyalty programs that they are enrolled in since they understandably wish to maximize their saving and maximize their rewards relative to the loyalty programs.

### BRIEF DESCRIPTION OF THE DRAWINGS

Features and advantages of some embodiments of the present invention, and the manner in which the same are accomplished, will become more readily apparent upon consideration of the following detailed description of the invention taken in conjunction with the accompanying drawings, wherein:

FIG. 1 an illustrative depiction of a system that may facilitate one or more processes herein, according to some embodiments herein;

FIG. 2 is a flow diagram of a process, according to some embodiments herein;

FIG. 3 is a flow diagram of a process, in accordance with some embodiments herein;

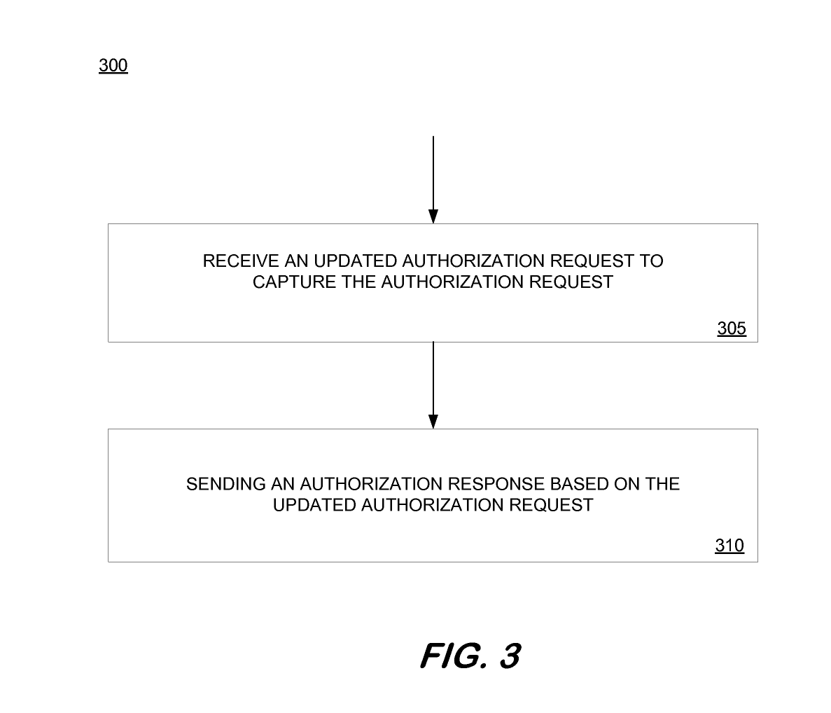

FIG. 4 is an illustrative depiction of a system that may facilitate one or more processes herein, according to one embodiment herein;

FIG. 5 is a flow diagram of a process, according to some embodiments herein;

FIG. 6 is a flow diagram of a process, according to some embodiments herein; and

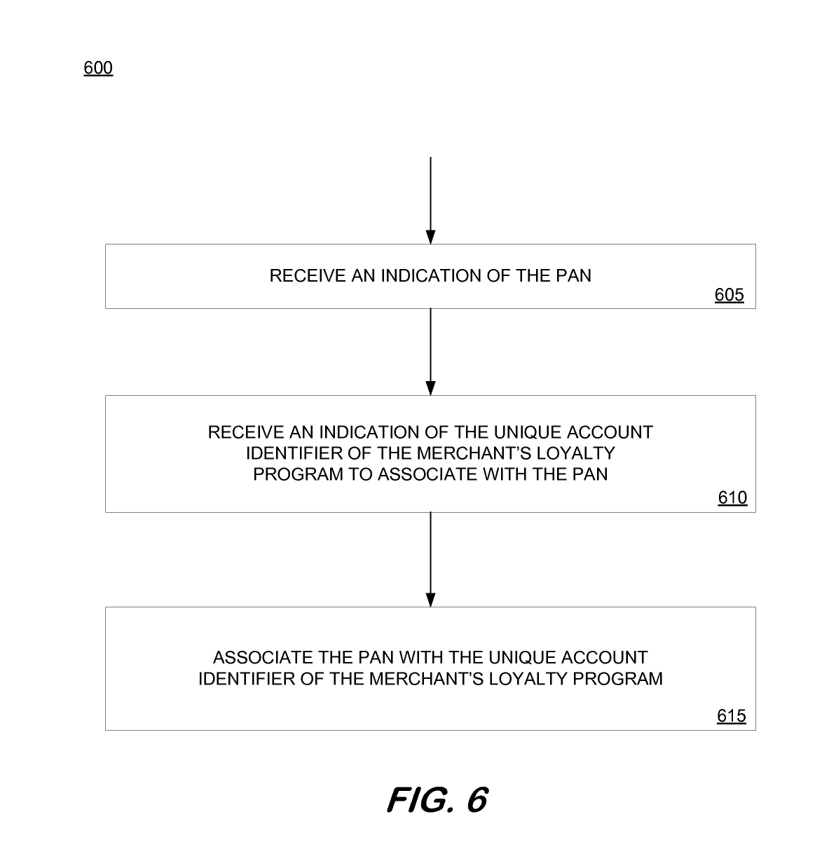

FIG. 7 is schematic block diagram of an apparatus, according to some embodiments herein.

### DETAILED DESCRIPTION

In general, and for the purpose of introducing concepts of embodiments of the present disclosure, a payment device refers to, in general, a payment device of any embodiment (e.g., card, mobile telephone, a key fob, etc.) associated with a payment account number (PAN) that may be used in a cashless payment or purchase transaction. As used herein, the terms purchase transaction and payment transaction or simply transaction may be used interchangeably unless stated otherwise. In general, the purchase transactions herein may refer to instances where a cardholder presents a payment device to a merchant and instances of an on-line or e-commerce transaction where the payment device is not present, without any loss of generality.

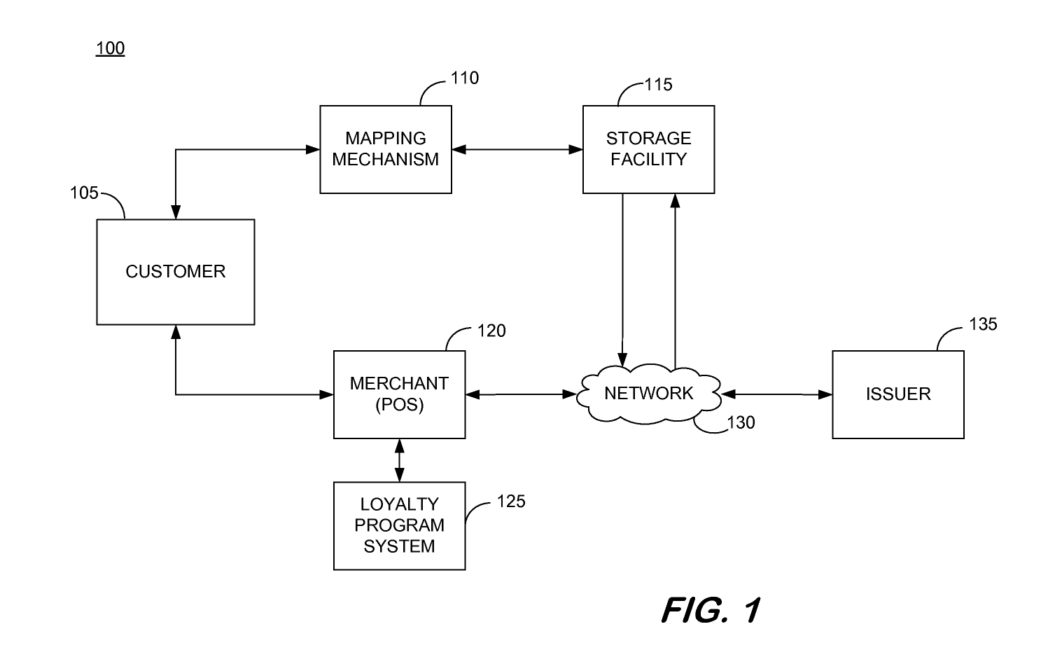

FIG. 1 is an illustrative block diagram of a system 100 that might be used to facilitate a mapping or associating of a cardholder's credit card to the cardholder's account in a merchant's loyalty program. In some aspects, the credit card and the merchant's loyalty program are separate, distinct, and unrelated to each other, including instances where the issuer of the credit card may or may not be the same entity as the merchant and where the credit card may or may not be “co-branded” with the merchant. In some aspects, system 100 provides a platform to map a payment account number (PAN) associated with a credit card, debit card, stored value card, and other payment devices having an associated payment account with an account in a merchant's loyalty program. As used herein, a “loyalty” program may be any form of loyalty, rewards, incentive, points, or club program associated with a merchant (e.g., pharmacies, supermarkets, gyms, hotels, airlines, and other providers of goods and services) that might track one or more aspects of a member user's activities related to the merchant. System 100 may further be used in processing a transaction using the credit card that is mapped to the cardholder's account in the merchant's loyalty program.

Referring to FIG. 1, it may be assumed that a merchant 120 has an existing loyalty program to which customer 105 is a registered participant or member. As is known, customer 105 may be provided with a card, key chain fob, or other token bearing a unique account identifier that identifies the customer's account within the loyalty program. Each registered participant in the merchant's loyalty program is assigned a unique account identifier so that the merchant may differentiate and identify its loyalty program members.

The unique account identifier may be represented by a sting of letters and/or numbers, a bar code, an icon, a “QR” (quick response) code, a near field communication (NFC) tag, and other indicia and tokens. Having possession of their credit card's associated PAN and their unique account identifier for a merchant's loyalty program, customer 105 may log into or otherwise access mapping mechanism 110 to initiate mapping or associating their PAN with their unique account identifier for the merchant's loyalty program. Mapping mechanism 110 may be accessed by customer 105 via an Internet web site, an “app” executing on a smartphone, tablet, or other device, a dedicated computing device such as a kiosk at a merchant's location or a financial institution, and other devices and facilities. Mapping mechanism 110 may, at the request of customer 105, receive the customer's PAN and map or associate the PAN with the customer's unique account identifier for the merchant's loyalty program.

In some aspects, customer 105 may map one particular PAN with loyalty programs of multiple different merchants. Typically, the customer will have a loyalty card for each of the multiple different merchants whose loyalty programs they are members of. In accordance with aspects herein, customer 105 may, via mapping mechanism 110, have a credit card (PAN) mapped to one or more of the merchant loyalty programs to which they belong. In some aspects, more than one PAN may be mapped to each of the multiple different merchants' loyalty programs. Significantly, mapping mechanism 110 establishes a mapped association between the PAN and the merchant's loyalty program, under the selective control of customer 105.

Upon mapping a PAN with a unique account identifier of a merchant's loyalty program at mapping mechanism 110, a record of the generated association represented by the mapping is stored at storage facility 115. Storage facility 115 may be embodied as any type of data store, including a hard disk drive, non-volatile memory, a server, a database (relational or otherwise), a “cloud”-based storage, a distributed database, combinations thereof, and other storage configurations. In some aspects, mapping mechanism 110 and storage facility 115 may compromise a mapping server or service provided by a common entity. The entity providing the mapping service or server may be a payment network provider, a payment network servicer or agent, and other third party service providers or vendors.

In some embodiments, mapping mechanism 110 may be a service or feature facilitated or offered by a merchant such as, for example, merchant 120. In some regards, merchant 120 may offer members of its loyalty program the option of “registering” a PAN with their loyalty account for that merchant. This offering may benefit the merchant's loyalty program members by providing, for example, the convenience of having their credit card also serve as an identifier of their account number in the merchant's loyalty program. In this manner, the loyalty card member opting to register a PAN of at least one of their credit cards with their loyalty account for that merchant may alleviate the need to also carry the merchant's loyalty card. The convenience of such a benefit is noteworthy since the customer might likely carry the credit card with them in most instances, particularly when visiting a merchant since a primary function of the credit card is to act as a form of payment.

A process of registering a credit card with mapping mechanism 110 that maps the credit card to the customer's unique account identifier for a merchant's (e.g., 120) loyalty program and storing a record of the mapping at storage facility 115 may occur without any dependence on any other entities represented in FIG. 1. In some aspects, the mapping and storing of the record of the mapping's association may occur before a purchase or payment transaction using system 100 makes a call or request for the record of the mapping.

In some aspects, the merchant's loyalty program is represented in FIG. 1 by loyalty program system 125. Loyalty program system 125 and the resources to establish and maintain the merchant's loyalty program may be provided by merchant 120 and/or a loyalty or rewards service or servicer (not shown). In some regards herein, aspects of the mapping of the customer's credit card (PAN) to the customer's unique account identifier for the merchant's 120 loyalty program and the storing of a record thereof are separate from loyalty program system 125 and the administration thereof. In some embodiments, merchant 120 and/or another entity (not shown) administering loyalty program system 125 maintains and supports the loyalty program in a manner that is separate and apart from the operations of mapping mechanism 110 and storage facility 115. In some aspects, the administration, maintenance, and support of the loyalty program system 125 for merchant 120 is not altered by the credit card to loyalty mapping aspects herein.

A purchase transaction may commence when customer 105 presents their credit card to merchant 120 to initiate a purchase of goods and services from the merchant. Customer 105 may provide their credit card (PAN) to use in the transaction, as well as other personally identifiable information (e.g., name, address, shipping address, etc.) that may be used by merchant 120 or other entities in a transaction processing flow. In some instances, customer 105 may present the credit card to merchant 120 via a point of sale terminal that uses either a contact or contactless reader to obtain the PAN from the user or the transaction may be an online or ecommerce transaction.

Based on the PAN received from customer 105 and other transaction details, merchant 120 sends an authorization request to a payment network 130 to have the transaction authorized. In some aspects herein, the authorization might be an “authorization only” type of authorization where the request is for an authorization only, not including a “capture”. In one aspect, the authorization request (“authorization only”) is received by payment network 130 and routed to the appropriate issuer for the credit card (PAN) information included in the authorization request. Issuer 135 may provide a authorization reply that includes an indication of whether the authorization request is approved or denied based on the information submitted in the authorization request (“authorization only”).

In some embodiments, at least some of the information included in the authorization request may be intercepted or parsed therefrom and used to determine whether the PAN used in the transaction is associated with the loyalty program of the merchant 120 also participating in the transaction. The PAN and a merchant ID are typically included in an authorization request, although additional and other information may be included in the transaction details thereof such as, for example, a merchant terminal ID, line item details related to the items being purchased, and anti-fraud data items.

In accordance with some embodiments herein, the PAN and the merchant ID may be used to determine whether the PAN used in the transaction is associated with the loyalty program of the merchant 120 by, for example, comparing the PAN and the merchant ID included in the authorization request with mapping records stored at storage facility 115. The merchant ID may be used to determine which merchant is participating in the transaction. For example, the merchant ID may indicate the merchant is a pharmacy (e.g., “CVS”). Accordingly, the PAN and the merchant's identity may be used in a query of the mapping records at storage facility 115 to determine if the PAN in the transaction is associated with an account for the particular merchant (e.g., “CVS”). If a match is found in the stored mappings, then an indication is provided via network 130 to merchant 120 that the PAN's user is a member of the merchant's loyalty program and an indication of the unique account identifier for the merchant's loyalty program corresponding to the PAN, as identified in the mapping record.

In some aspects, the indication that the PAN's user is a member of the merchant's loyalty program may be implemented in any type of indicator or field of a message, including a binary flag that indicates “yes” for being a member or “no” for not being a member of the merchant's loyalty program. In some embodiments, it may be assumed that the customer is a member of the merchant's loyalty program if an indication of the unique account identifier for the merchant's loyalty program is retuned as a result of the comparison with the stored mappings.

In some aspects, the indication of whether the PAN's user is a member of the merchant's loyalty program and the indication of the unique account identifier for the merchant's loyalty program may be provided in, with or appended to the authorization reply from issuer 135 in reply to the authorization (“authorization only”) request. In some aspects, the information regarding the loyalty program may be included in the authorization reply in previously unused fields, in modified fields, or in new fields added to accommodate the loyalty program information. In some aspects, the information regarding the loyalty program may not be provided in, with or appended to the authorization reply from issuer 135. The information regarding the loyalty program may be included in one or more other messages or notifications, without limit to a specific type or message.

Having received the authorization reply that includes, at least, the indication of the unique account identifier for the merchant's loyalty program for the transaction's PAN, merchant 120 may cooperate with loyalty program system 125 to apply loyalty incentives to the current transaction. Such incentives may include, but are not limited to, the earning of discounts, points, and other rewards such as prizes or cash. In some aspects, applying the incentives to the current transaction may change the total amount due for the transaction. Accordingly, an updated authorization request might be sent to issuer 135 that includes the adjusted transaction total to be used to “capture” the transaction. In the instance applying the incentives to the current transaction do not change the total amount due for the transaction, an authorization request to “capture” the transaction may be made with the same transaction total used in the initial authorization request (“authorization only”).

In reply to the authorization request to “capture” the transaction, issuer 135 may determine whether to approve or deny the transaction. Issuer 135 may then send an authorization response to merchant 120 via network 130 that includes an indication of whether the transaction is approved or denied.

In some embodiments, the communication of the PAN and the merchant's identity (e.g., merchant ID) used in a query of the mapping records at storage facility 115 to determine if the PAN in the transaction is associated with an account for the particular merchant 120 may be sent to storage facility 115 via one or more messages over a network (e.g., 130 or another) that is separate and distinct from any type of authorization request. Accordingly, in some embodiments the query of the mapping records is substantially independent of an authorization and may, for example, occur before an authorization request is generated or sent to a payment network for approval.

In some aspects, the mapping and storing of the record of the mapping's PAN-to-loyalty account association may be done to initially register an association of the PAN with the account identifier for the merchant's loyalty program. Thereafter, customer 105 need not log into mapping mechanism 110 since a record of the mapping is maintained at storage facility 115. In the event the credit card information and/or the customer's account identifier for the merchant's loyalty program changes, then the customer may access mapping mechanism 110 to have the mapping and the record thereof appropriately updated.

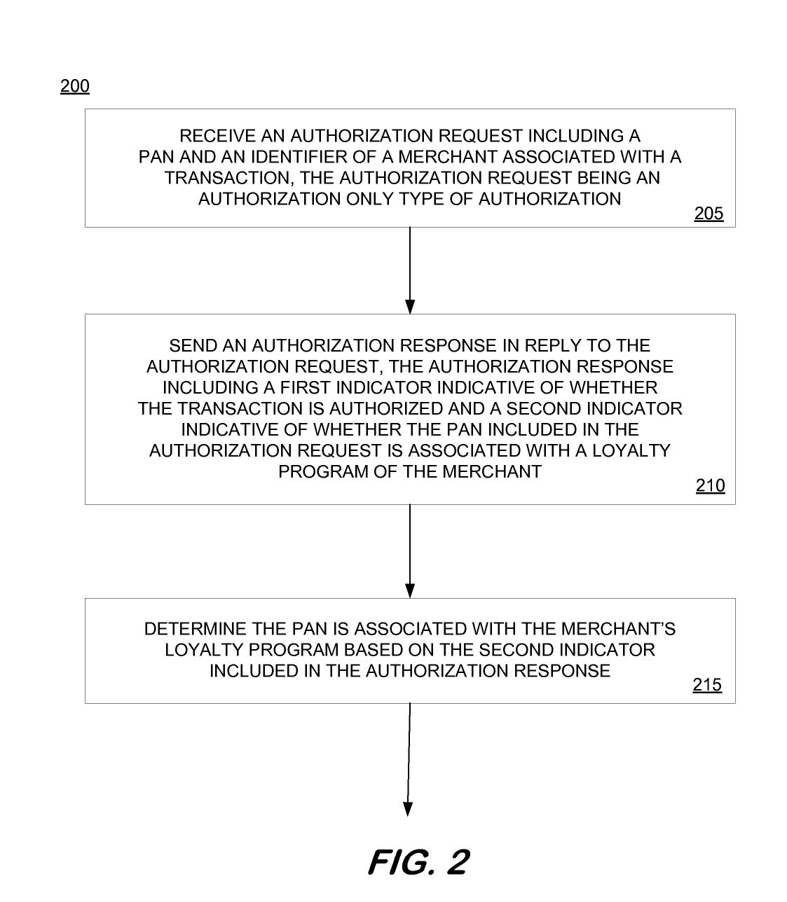

FIG. 2 is an illustrative flow diagram of a process according to some embodiments herein, generally represented by the reference numeral 200. At operation 205, an authorization request is received. The authorization request may include a PAN and an identifier of a merchant associated with a transaction. The authorization request may include other information such as transactions details that may be associated with the transaction. The authorization request may be received by a payment network, a payment network servicer or agent, a payment network operator, or another entity (not shown). In some aspects herein, the authorization request of operation 205 may be an “authorization only” type of authorization.

At operation 210, process 200 sends an authorization response in reply to the authorization request of operation 205. The authorization response may include one or more fields, commands, or indicators of information. The one or more indicators may include a first indicator indicative of whether the transaction is authorized and a second indicator that is indicative of whether the PAN included or referenced in the authorization request of operation 205 is associated with a loyalty program of the merchant.

At operation 215, a determination is made whether the PAN provided in the authorization request is associated with the merchant's loyalty program. The determination of operation 215 may be based on, at least in part, the second indicator included in the authorization response that is received at operation 210.

In some embodiments, process 200 may form or comprise a portion of other processes. In some regards, one or more of the operations of process 200 may be incorporated before, after, or amongst other processes and operations. For example, process 300 may, in some embodiments, follow after an executing instance of one or more operations of process 200. At operation 305 an updated authorization request to capture an earlier authorization request (e.g., the authorization request of operation 205) may be received. In some instances, the updated authorization request may include an adjusted transaction total amount that results from applying an incentive or reward to a transaction total included in, for example, the transaction request of operation 205. In some instances, the updated authorization request may not necessarily include an adjusted transaction total amount.

In some embodiments, process 300 may too occur in isolation or in combination with other processes or portions of other processes herein.

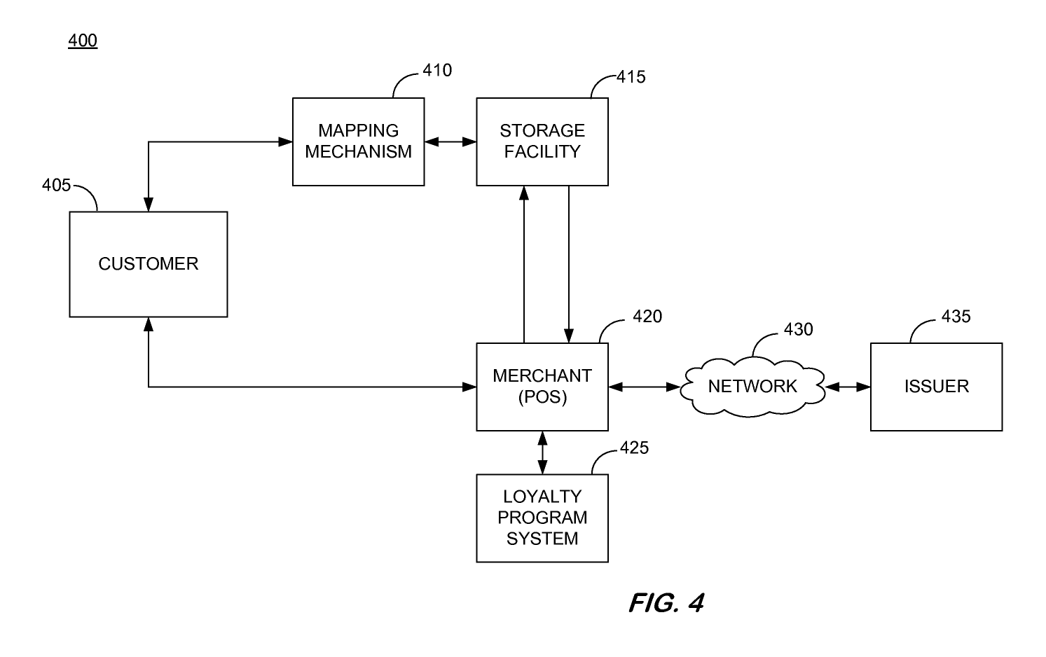

FIG. 4 is an illustrative block diagram of a system 400 that might be used to facilitate a mapping or associating of a cardholder's credit card to the cardholder's account in a merchant's loyalty program. In some aspects, the credit card and the merchant's loyalty program are separate, distinct, and unrelated to each other. In some aspects, system 400 provides a platform to map a PAN associated with a credit card, debit card, stored value card, and other payment devices having an associated payment account with an account in a merchant's loyalty program. With respect to FIG. 4, the merchant's loyalty program may be represented by loyalty program system 425. Loyalty program system 425 may encompass some or all aspects of a merchant's loyalty program, including the infrastructure and control system(s) responsible for the maintenance and operations thereof. System 400 may also be used, in some embodiments, in processing a transaction using the credit card that is mapped to the cardholder's account in the merchant's loyalty program.

In one embodiment of FIG. 4, it may be assumed that merchant 420 has an existing loyalty program 425 and customer 405 is a registered participant or member in the loyalty program. As a consequence of being a member in the loyalty program 425, customer 405 may be assigned a unique account identifier for the loyalty program and also provided with a card, key chain card or fob, or other token bearing that unique account identifier. As is known, each registered participant in the merchant's loyalty program may be assigned their own unique account identifier so that the merchant and/or merchant loyalty program system may differentiate and track the actions of the loyalty program members.

Customer 405 may initially register one of more credit cards (PANs) with one or more merchant loyalty programs to which they belong by having the credit cards (PANs) mapped to the loyalty program of their choosing by mapping mechanism 410. Mapping mechanism 400 may be provided by, on behalf of, or for the benefit of merchant 420. Mapping mechanism 420 may operate to generate a record of a mapped association between a PAN and the customer's unique identifier for the one or more merchants' loyalty program, which may be selectively initiated by the customer. The record(s) generated by mapping mechanism 410 may be stored by a data store such as storage facility 415 for use in a future process. Mapping mechanism 410 and storage facility 415 may, alone or combination, be implemented by one or more devices including a processor such as a computer. In some aspects, one of the future processing uses herein may include a purchase or payment transaction using a credit card (PAN) that is mapped to a merchant's loyalty program.

In some embodiments, a purchase transaction may commence when customer 405 presents their credit card (PAN) to merchant 420 to initiate a purchase for goods and services from merchant 420. Customer 405 may provide their PAN to use in the transaction, as well as other personally identifiable information (e.g., name, address, shipping address, etc.) that may be used by merchant 420 or other entities in the transaction processing chain. In some instances, customer 405 may present the credit card to merchant 420 via a point of sale (POS) terminal that uses either a contact or contactless reader to obtain the PAN from the user or the transaction may be an ecommerce transaction.

Based on the PAN received from customer 405 and other transaction details, merchant 420 may exchange information with storage facility 415 as part of a process to determine whether the PAN used (or to be used) in the transaction is mapped to an account in the merchant's loyalty program belonging to customer 405. In some embodiments, the PAN used in the transaction and an identifier indicative of the merchant's identity (e.g., a merchant ID) may primarily be used as the basis for determining whether the PAN used in the transaction is mapped to an account in merchant's loyalty program belonging to customer 405. In some examples herein, a request including the PAN and the merchant ID may be received by merchant 405, a merchant servicer or agent, a merchant acquirer, or another entity (not shown).

In the example of FIG. 4, the request including the PAN and the merchant ID is received by merchant 420. Merchant 420 (or other entity) may further receive or obtain a record of the PAN-to-loyalty account mappings stored by storage facility 415. Based on a comparison or analysis of the record(s) and the PAN and the merchant ID received in the request, merchant 420 (or other entity) may make a determination of whether the PAN received in the request and used (or to be used) in the transaction is associated with a loyalty program account belonging to customer 420.

In the event it is determined that the PAN received in the request and used (or to be used) in the transaction is associated with a loyalty program account belonging to customer 405 for merchant 420, then merchant 420 may interact with its loyalty program system 425 to confer rewards and incentives to customer 405 as dictated by the rules governing the loyalty program system 425.

In the event it is determined that the PAN received in the request and used (or to be used) in the transaction is not associated with a loyalty program account belonging to customer 405 for merchant 420, then merchant 420 may not need to interact with its loyalty program system 425 since customer 405 is not a participant member whose credit card (PAN) has been mapped to their loyalty program account for merchant 420.

In some aspects, system 400 supports a processing of credit card transaction including authorization requests and authorization responses thereto. In some embodiments, merchant 420 may interact with its loyalty program 425 and apply one or more incentives to a transaction and an authorization for the transaction may be processed by payment network 430 and issuer 435 in a conventional manner.

As illustrated by the discussion of FIG. 4, the determination of whether the PAN received in the request and used (or to be used) in the transaction is associated with a loyalty program account belonging to customer 420 may be determined, in some aspects at a local level, whereas a same or similar determination may be made in connection with system 100 of FIG. 1 at a network level.

As illustrated in the description of FIGS. 1 and 4, a customer may effectively and efficiently initiate a transaction using a credit card wherein the credit card may act as both a payment device and an identifier of the customer's membership in the transaction merchant's loyalty program.

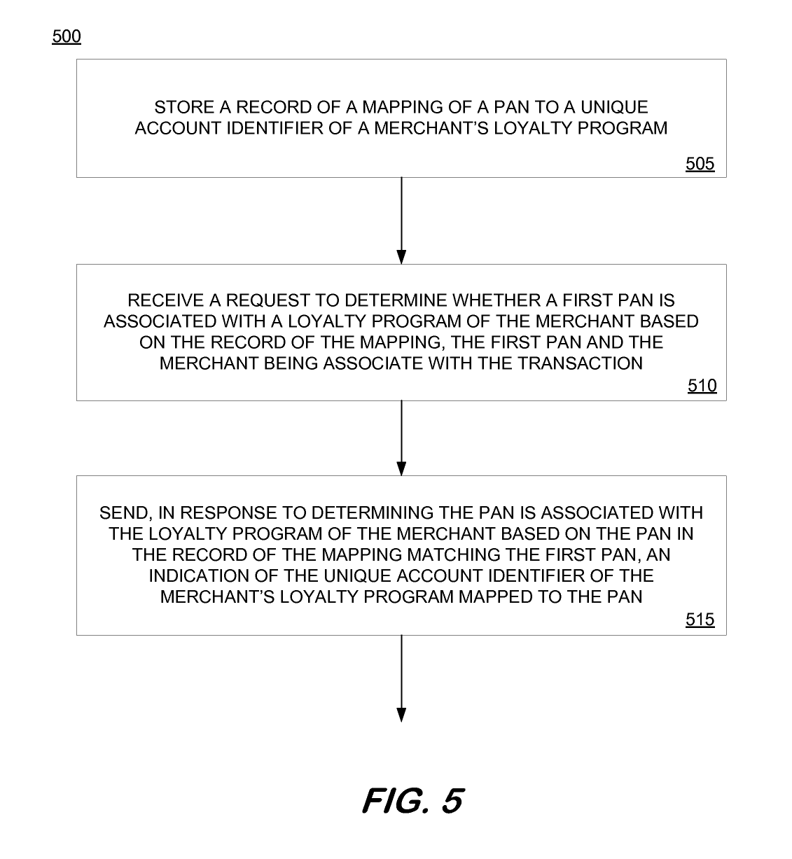

FIG. 5 relates is a flow diagram of a process that may be supported, in some respects, by the system of FIG. 4. At operation 505, a record of a mapping of a PAN to a unique account identifier of a merchant's loyalty program is stored. The mapping may be initiated at the request of a customer who is the credit cardholder and a member in the merchant's loyalty program.

At operation 510, a request to determine whether a first PAN is associated with a loyalty program of the merchant is received. The first PAN as well as an identifier of the merchant (at least) is received in the request. In some aspects, the determination will be made on the basis of the record of operation 505. The determination process may include a comparison or other analysis of the record of the mapping (i.e. a PAN associated with a unique loyalty account identifier) with the first PAN and the merchant identifier. An output of the determination may be an indication that the first PAN matches or does not match the PAN in the record of the mapping. If the first PAN matches the PAN in the record of the mapping, then it is understood that the credit card (PAN) is mapped to the customer's unique account identifier for the merchant in the record. Accordingly, the first PAN received from the customer can be used as a representative proxy for the customer's loyalty account identifier (e.g., a physical key chain card).

Operation 515 includes sending an indication of the unique account identifier of the merchant's loyalty program that has been determined to be mapped to the PAN received in the request. This indication may be sent to the merchant's loyalty program so that rewards and other incentives may be awarded to or applied to the customer's loyalty account, as applicable loyalty program rules may govern.

In some embodiments, process 600 may form or comprise a portion of other processes. In some regards, one or more of the operations of process 600 may be incorporated before, after, or amongst other processes and operations. For example, process 600 may, in some embodiments, follow after an executing instance of one or more operations of process 500. At operation 605 an entity such as a mapping service or servicer (e.g., 410/415) may receive an indication of a PAN from a customer. This entity may further receive an indication of the customer's unique account identifier for a merchant's loyalty program that is to be mapped to the received PAN at operation 610. At operation 615, the received PAN is mapped or associated with the customer's unique account identifier for a merchant's loyalty program.

In some embodiments, process 600 may occur in isolation or in combination with other processes or portions of other processes herein.

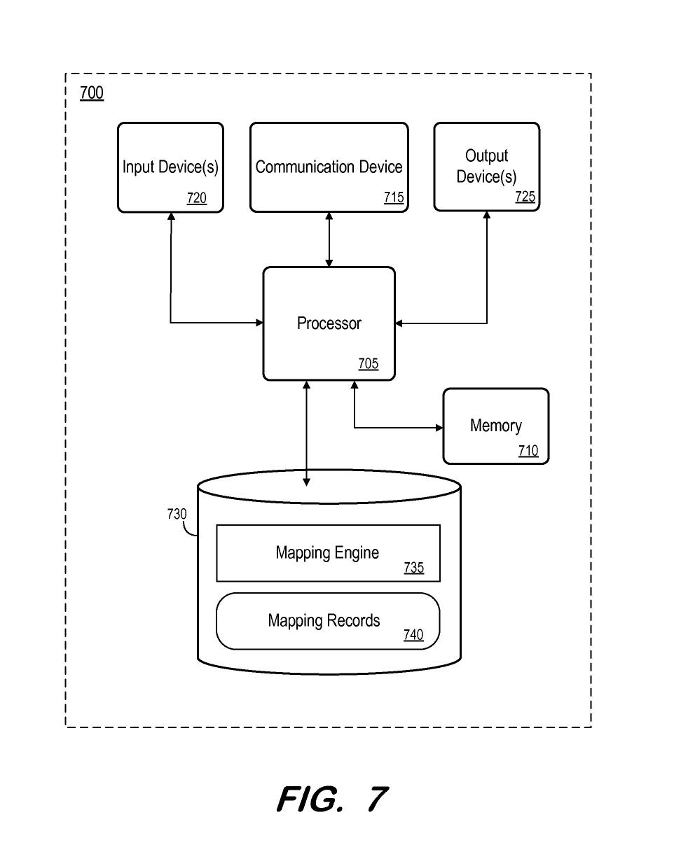

FIG. 7 is a block diagram overview of a system or apparatus 700 according to some embodiments. System 700 may be, for example, associated with any of the devices described herein, including for example a merchant system device and an application server supporting or providing a mapping mechanism (e.g., 110, 410) and a storage facility (e.g., 115, 415). System 700 comprises a processor 705, such as one or more commercially available Central Processing Units (CPUs) in the form of one-chip microprocessors or a multi-core processor, coupled to a communication device 715 configured to communicate via a communication network (not shown in FIG. 7) with another device or system. In the instance system 700 comprises a server (e.g., supporting the functions and services provided by a mapping mechanism and its associated storage facility), communication device 715 may provide a means for system 700 to interface with a client device (e.g., a merchant system device). System 700 may also include a local memory 710, such as RAM memory modules. The system further includes an input device 720 (e.g., a touchscreen, mouse and/or keyboard to enter content) and an output device 725 (e.g., a touchscreen, a computer monitor to display, a LCD display).

Processor 705 communicates with a storage device 730. Storage device 730 may comprise any appropriate information storage device, including combinations of magnetic storage devices (e.g., a hard disk drive), optical storage devices, and/or semiconductor memory devices. In some embodiments, storage device may comprise a database system.

Storage device 730 stores program code and mapping records 740, in accordance with processes herein. Processor 705 may perform the instructions of program code stored by storage device 730 to thereby operate in accordance with any of the embodiments described herein. Program code may be stored in a compressed, uncompiled and/or encrypted format. Program code may furthermore include other program elements, such as an operating system, a database management system, and/or device drivers used by the processor 705 to interface with, for example, peripheral devices. Storage device 730 may include data 740 such as database records or look-up tables of the mapping records. Mapping engine 735 may be used by system 700, in some aspects, in performing the processes herein, including the mapping of a PAN to a loyalty account identifier for a merchant's loyalty program.

All systems and processes discussed herein may be embodied in program code stored on one or more non-transitory computer-readable media. Such media may include, for example, a floppy disk, a CD-ROM, a DVD-ROM, magnetic tape, and solid state Random Access Memory (RAM) or Read Only Memory (ROM) storage units. According to some embodiments, a memory storage unit may be associated with access patterns and may be independent from the device (e.g., magnetic, optoelectronic, semiconductor/solid-state, etc.) Moreover, in-memory technologies may be used such that databases, etc. may be completely operated in RAM memory at a processor. Embodiments are therefore not limited to any specific combination of hardware and software.

Embodiments have been described herein solely for the purpose of illustration. Persons skilled in the art will recognize from this description that embodiments are not limited to those described, but may be practiced with modifications and alterations limited only by the spirit and scope of the appended claims.

What is claimed is:

1. A computer-implemented method, the method comprising:
receiving, by a computer, an authorization request including a payment account number (PAN) and an identifier of a merchant associated with a transaction, the authorization request being an authorization only type of authorization;
determining whether the PAN is associated with a loyalty program of the merchant based on a record of a mapped association between the PAN and a unique account identifier of the merchant's loyalty program; and
sending, by the computer, an authorization response in reply to the authorization request, the authorization response including a first indicator indicative of whether the transaction is authorized and a second indicator indicative of whether the PAN included in the authorization request is associated with the loyalty program of the merchant.

2. The method of claim 1, further comprising:
receiving an updated authorization request to capture the authorization request; and
sending an authorization response based on the updated authorization request.

3. The method of claim 1, further comprising determining the transaction is authorized based on the first indicator included in the authorization response.

4. The method of claim 1, further comprising:
applying a reward incentive to the transaction based on the PAN being determined to be associated with the merchant's loyalty program.

5. The method of claim 4, wherein the applying of the reward incentive to the transaction includes, at least, adjusting an authorized amount of the authorization request.

6. The method of claim 5, wherein the updated authorization request to capture the authorization request includes the adjusted authorized amount.

7. The method of claim 4, further comprising receiving an indication a user approves applying the reward incentive to the transaction prior to the application of the reward incentive to the transaction.

8. The method of claim 1, wherein the PAN is associated with a plurality of different reward programs of a plurality of different merchants.

9. The method of claim 1, wherein at least one of a payment network provider and a payment network servicer maintains the record of the mapped association between the PAN and a unique account identifier of the merchant's loyalty program.

10. A computer-implemented method, the method comprising:
obtaining, by a computer, a record of a mapping of a payment account number (PAN) to a unique account identifier of a merchant's loyalty program;
receiving a request to determine whether a first PAN is associated with a loyalty program of the merchant based on the record of the mapping, the first PAN and the merchant being associated with the transaction; and
sending, in response to determining that the PAN is associated with the loyalty program of the merchant based on the PAN in the record of the mapping matching the first PAN, an indication of the unique account identifier of the merchant's loyalty program mapped to the PAN.

11. The method of claim 10, further comprising mapping the PAN to the unique account identifier of the merchant's loyalty program.

12. The method of claim 11, wherein the mapping comprises:
receiving an indication of the PAN;
receiving an indication of the unique account identifier of the merchant's loyalty program to associate with the PAN; and
associating the PAN with the unique account identifier of the merchant's loyalty program.

13. The method of claim 12, wherein the indication of the unique account identifier of the merchant's loyalty program is at least one of a string of alpha-numeric characters, a photograph of a token of the first merchant's loyalty program, and a computer-readable indicia.

14. The method of claim 10, wherein the request to determine whether the first PAN is associated with a loyalty program is received from the merchant and the indication of the unique account identifier of the merchant's loyalty program mapped to the PAN is sent to the merchant.

15. The method of claim 10, further comprising sending, in response to determining the PAN is not associated with the loyalty program of the merchant based on the PAN in the record of the mapping not matching the first PAN, an indication that the PAN is not associated with the merchant's loyalty program.

16. The method of claim 10, wherein the PAN is mapped to a unique account identifier of a loyalty program for a plurality of different merchants.

17. The method of claim 10, wherein at least one of a payment network provider and a payment network servicer maintains the storing of the record of the mapping.
